(19) United States
(12) Patent Application Publication
(10) Pub. No.: US 2022/0219528 A1
(43) Pub. Date: Jul. 14, 2022

(54) FUEL CELL VEHICLE

(71) Applicant: TOYOTA JIDOSHA KABUSHIKI KAISHA, Toyota-shi (JP)

(72) Inventors: Naoki OGIWARA, Nagoya-shi (JP); Tomonori KANEKO, Nagoya-shi (JP)

(73) Assignee: TOYOTA JIDOSHA KABUSHIKI KAISHA, Toyota-shi (JP)

(21) Appl. No.: 17/572,608

(22) Filed: Jan. 10, 2022

(30) Foreign Application Priority Data
Jan. 12, 2021 (JP) 2021-002985

(51) Int. Cl. B60K 15/07; B62D 27/00; B60L 50/71

(52) U.S. Cl. CPC B60K 15/07; B60K 2001/0438; B60L 50/71; B62D 27/00

(57) ABSTRACT

A fuel cell vehicle includes a vehicle body, a tank mounted on the vehicle body, a fuel cell unit configured to generate electricity by using gas supplied from the tank, and a first band configured to fix the tank to the vehicle body. The tank includes a valve-side end including a cap to which an automatic valve is attached, a base-side end opposite to the valve-side end, and a cylindrical tank side surface extending between the valve-side end and the base-side end. The first band extends in a circumferential direction along the tank side surface, and is located within a range of a first predetermined distance ±15 mm from the base-side end or within a range of a second predetermined distance ±15 mm from the valve-side end.

### CROSS-REFERENCE TO RELATED APPLICATION

This application claims priority to Japanese Patent Application No. 2021-002985 filed on Jan. 12, 2021, incorporated herein by reference in its entirety.

### BACKGROUND

### 1. Technical Field

The technology disclosed herein relates to a fuel cell vehicle.

### 2. Description of Related Art

Japanese Unexamined Patent Application Publication No. 2019-98802 (JP 2019-98802 A) discloses a fuel cell vehicle. This fuel cell vehicle includes a vehicle body, a tank mounted on the vehicle body to store gas, a fuel cell unit that generates electricity by using the gas supplied from the tank, and a plurality of bands for fixing the tank to the vehicle body.

### SUMMARY

In general, an automatic valve such as a solenoid valve is attached to a cap of the tank. The automatic valve generates operating noise such as clicking noise when the valve is opened and closed. The operating noise (vibration) of the automatic valve may be transmitted from the automatic valve to the tank, from the tank to the band, and from the band to the vehicle body and perceived by a user in the vehicle. The operating noise of the automatic valve is unnecessary for the user. The perception of such operating noise by the user may be a factor that reduces the commercial value of the fuel cell vehicle.

In view of the above, provided herein is a technology capable of suppressing the perception of the operating noise of the automatic valve provided in the tank by the user in the vehicle.

One aspect of the present disclosure provides a fuel cell vehicle. This fuel cell vehicle includes a vehicle body, a tank mounted on the vehicle body and configured to store gas, a fuel cell unit configured to generate electricity by using the gas supplied from the tank, and a first band configured to fix the tank to the vehicle body. The tank includes a valve-side end including a cap to which an automatic valve is attached, a base-side end opposite to the valve-side end, and a cylindrical tank side surface extending between the valve-side end and the base-side end. The first band extends in a circumferential direction along the tank side surface, and is located within a range of a first predetermined distance ±15 mm from the base-side end or within a range of a second predetermined distance ±15 mm from the valve-side end. The first predetermined distance and the second predetermined distance are values determined depending on a length of the tank. The following relational expressions are satisfied: Y1=0.24×L−41.5 mm, and Y2=0.17×L−12.5 mm, where Y1 represents the first predetermined distance, Y2 represents the second predetermined distance, and L represents the length of the tank.

According to research conducted by the inventors, it has been found that the operating noise (vibration) of the automatic valve has a common characteristic and the tank vibrates in a specific mode when the operating noise is transmitted to the tank. In this specific mode, a center point in a longitudinal direction of the tank vibrates with the largest amplitude as an antinode of vibration. In a section between the center point and the base-side end and in a section between the center point and the valve-side end, points having minimum amplitudes appear as nodes of vibration, respectively. It has been found that the positions of the nodes can be determined depending on the length of the tank, that is, can be determined based on the two relational expressions described above. Based on the findings described above, in the fuel cell vehicle, the first band configured to fix the tank to the vehicle body is provided at or near the position of the vibration node. As a result, it is possible to effectively suppress the transmission of the operating noise of the automatic valve provided in the tank to the vehicle body from the tank through the first band. That is, it is possible to suppress the perception of the operating noise by the user in the vehicle.

In the aspect described above, the fuel cell vehicle may further include a second band extending in the circumferential direction along the tank side surface and configured to fix the tank to the vehicle body. In this case, the first band may be located within the range of the first predetermined distance ±15 mm, and the second band may be located within the range of the second predetermined distance ±15 mm. According to this structure, the tank can firmly be fixed to the vehicle body by the two bands while suppressing the transmission of the operating noise of the automatic valve to the vehicle body.

In the aspect described above, the fuel cell vehicle may further include a neck mount configured to fix the valve-side end of the tank to the vehicle body. According to this structure, the valve-side end where the automatic valve is attached and its inertial force acts can be stabilized on the vehicle body.

In the aspect described above, the length of the tank may be 500 mm or more and 1800 mm or less. Further, the length of the tank may be 700 mm or more and 1600 mm or less. When these numerical conditions are satisfied, the two relational expressions related to the first predetermined distance and the second predetermined distance can accurately exert their functions.

In the aspect described above, a diameter of the tank may be 200 mm or more and 400 mm or less. Further, the diameter of the tank may be 250 mm or more and 350 mm or less. When these numerical conditions are satisfied, the two relational expressions related to the first predetermined distance and the second predetermined distance can accurately exert their functions.

In the aspect described above, the tank may be made of a carbon fiber reinforced resin. According to this structure, the two relational expressions related to the first predetermined distance and the second predetermined distance can accurately exert their functions.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a left side view of a fuel cell vehicle of an embodiment;

FIG. 2 illustrates the electrical configuration of the fuel cell vehicle;

FIG. 3 illustrates a first tank fixed to a vehicle body;

FIG. 4 illustrates a second tank (or a third tank) fixed to the vehicle body;

FIG. 5 illustrates the internal structure of a solenoid unit of an automatic valve;

FIG. 6 schematically illustrates how the tank vibrates in a specific mode;

FIG. 7 illustrates simulation results regarding a position of a first node, in which the horizontal axis represents a length of the tank and the vertical axis represents a distance from a base-side end to the first node;

FIG. 8 illustrates simulation results regarding a position of a second node, in which the horizontal axis represents the length of the tank and the vertical axis represents a distance from a valve-side end to the second node;

FIG. 9 illustrates a frequency distribution of inertance measured in the vehicle of the embodiment, in which the horizontal axis represents a frequency and the vertical axis represents the inertance; and

FIG. 10 illustrates a frequency distribution of inertance measured in a related-art vehicle as a comparative example, in which the horizontal axis represents the frequency and the vertical axis represents the inertance.

### DETAILED DESCRIPTION OF EMBODIMENTS

A fuel cell vehicle 10 of an embodiment (hereinafter referred to simply as “vehicle 10”) will be described with reference to the drawings. The vehicle 10 of this embodiment is one type of so-called automobile, and travels on roads. In the drawings, a direction FR indicates a front in a fore-and-aft direction (vehicle length direction) of the vehicle 10, and a direction RR indicates a rear in the fore-and-aft direction of the vehicle 10. A direction LH indicates a left in a lateral direction (vehicle width direction) of the vehicle 10, and a direction RH indicates a right in the lateral direction of the vehicle 10. A direction UP indicates an upper side in a vertical direction (vehicle height direction) of the vehicle 10, and a direction DN indicates a lower side in the vertical direction of the vehicle 10. The fore-and-aft direction, the lateral direction, and the vertical direction of the vehicle 10 may herein be referred to simply as “fore-and-aft direction”, “lateral direction”, and “vertical direction”, respectively.

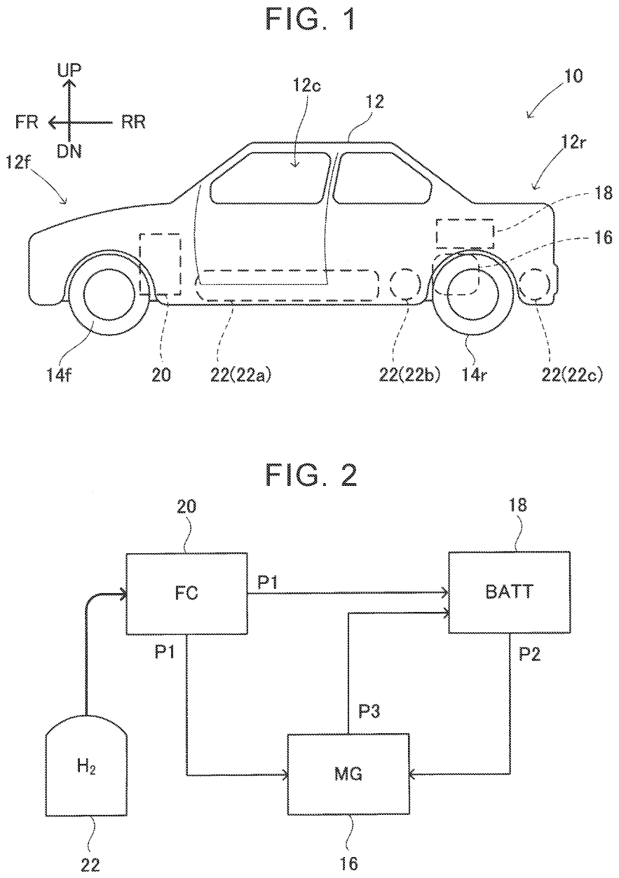

As illustrated in FIG. 1, the vehicle 10 includes a vehicle body 12 and a plurality of wheels 14f and 14r. The vehicle body 12 is mainly made of a metal material though the material is not particularly limited. The wheels 14f and 14r are rotatably attached to the vehicle body 12. The wheels 14f and 14r include a pair of front wheels 14f and a pair of rear wheels 14r. The number of wheels 14f and 14r is not limited to four. The vehicle body 12 can mainly be divided into a cabin 12c where a user rides, a front portion 12f located in front of the cabin 12c, and a rear portion 12r located behind the cabin 12c.

Referring also to FIG. 2, the vehicle 10 further includes a plurality of tanks 22 mounted on the vehicle body 12, and a fuel cell unit 20 also mounted on the vehicle body 12. The tanks 22 store gas to be supplied to the fuel cell unit 20. Although not particularly limited, each tank 22 in this embodiment is a constant-volume high-pressure tank, and stores hydrogen gas to be supplied to a fuel electrode (anode) of the fuel cell unit 20. The fuel cell unit 20 generates electricity by using the gas supplied from the tanks 22. Since the specific structure of the fuel cell unit 20 is known, detailed description of the structure will be omitted herein.

For example, the tanks 22 in this embodiment include a first tank 22a, a second tank 22b, and a third tank 22c. The first tank 22a is located below the cabin 12c, and is arranged along the fore-and-aft direction. The second tank 22b and the third tank 22c are arranged in the rear portion 12r of the vehicle body 12 along the lateral direction. The number of tanks 22 in the vehicle 10 is not limited to three. The vehicle 10 may include at least one tank 22. The length of the tank 22 may be 500 mm or more and 1800 mm or less. Further, the length of the tank 22 may be 700 mm or more and 1600 mm or less. The diameter of the tank 22 may be 200 mm or more and 400 mm or less. Further, the diameter of the tank 22 may be 250 mm or more and 350 mm or less. The tank 22 may be made of a carbon fiber reinforced resin.

The vehicle 10 further includes a traveling motor 16 and a battery pack 18. Although not particularly limited, the traveling motor 16 is arranged in the rear portion 12r. The traveling motor 16 is connected to the rear wheels 14r to drive the rear wheels 14r. The vehicle 10 may include another traveling motor that drives the front wheels 14f in addition to or in place of the traveling motor 16 that drives the rear wheels 14r. The vehicle 10 may include another prime mover such as an engine in addition to the traveling motor 16.

The battery pack 18 is arranged in the rear portion 12r of the vehicle body 12. The position of the battery pack 18 is not particularly limited. The battery pack 18 is electrically connected to the traveling motor 16 and the fuel cell unit 20. As described above, the fuel cell unit 20 generates electricity by using the gas supplied from the tanks 22. Electric power P1 generated by the fuel cell unit 20 is supplied to and consumed by the traveling motor 16. The electric power P1 generated by the fuel cell unit 20 is also supplied to and stored in the battery pack 18. For example, when the electric power P1 generated by the fuel cell unit 20 is insufficient, electric power P2 stored in the battery pack 18 is supplied to the traveling motor 16. When the traveling motor 16 generates regenerative electric power P3, the regenerative electric power P3 is supplied to and stored in the battery pack 18.

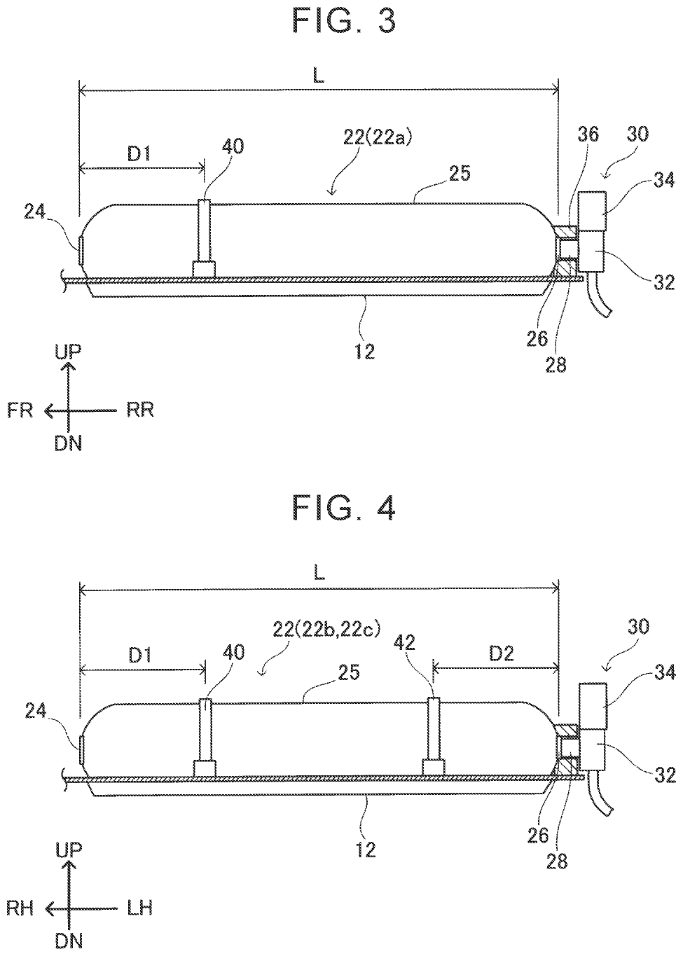

Next, the tanks 22 and structures for fixing the tanks 22 to the vehicle body 12 will be described with reference to FIGS. 3 and 4. As illustrated in FIGS. 3 and 4, each tank 22 includes a valve-side end 26, a base-side end 24 opposite to the valve-side end 26, and a cylindrical tank side surface 25 extending between the valve-side end 26 and the base-side end 24. A cap 28 is provided at the valve-side end 26. An automatic valve 30 is attached to the cap 28. Although not particularly limited, the automatic valve 30 in this embodiment is a solenoid valve, and includes a valve mechanism 32 and a solenoid unit 34 for driving the valve mechanism 32. The automatic valve 30 is controlled by a control unit (not illustrated). The automatic valve 30 is generally opened when the vehicle 10 is activated and closed when the vehicle 10 is stopped.

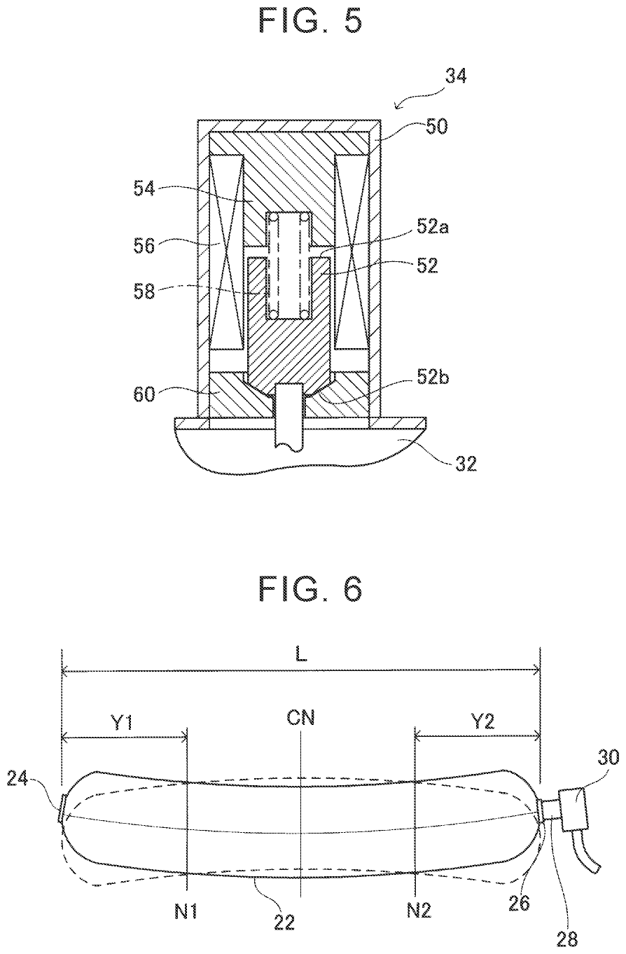

As illustrated in FIG. 5, the solenoid unit 34 includes a case 50 and a plunger 52, a stopper 54, a coil 56, a spring 58, and a body 60 arranged in the case 50. The plunger 52 is arranged between the stopper 54 and the body 60. The spring 58 is located between the plunger 52 and the stopper 54, and urges the plunger 52 toward the body 60. The plunger 52 is connected to the valve mechanism 32, and moves between the stopper 54 and the body 60 to open or close the valve mechanism 32.

That is, when the automatic valve 30 opens the valve mechanism 32, the plunger 52 is magnetized by energizing the coil 56. As a result, the plunger 52 moves toward the stopper 54. When one end 52a of the plunger 52 strikes the stopper 54, operating noise such as clicking noise is generated. When the automatic valve 30 is closed, the plunger 52 is demagnetized by stopping the energization of the coil 56. As a result, the plunger 52 moves toward the body 60 by an elastic force of the spring 58. When the other end 52b of the plunger 52 strikes the body 60, operating noise such as clicking noise is also generated.

Referring back to FIG. 3, the first tank 22a is fixed to the vehicle body 12 by using a first band 40. The first band 40 extends in a circumferential direction along the tank side surface 25, and both ends of the first band 40 are fixed to the vehicle body 12. For example, the width of the first band 40 may be 30 mm or more and 40 mm or less. The length of the first tank 22a is approximately 1530 mm, and the diameter of the first tank 22a is approximately 300 mm. A distance D1 from the base-side end 24 to the first band 40 is approximately 300 mm. These numerical values will be described in detail later. The first tank 22a is further fixed to the vehicle body 12 by using a neck mount 36. The neck mount 36 fixes the valve-side end 26 of the first tank 22a to the vehicle body 12.

As illustrated in FIG. 4, each of the second tank 22b and the third tank 22c is fixed to the vehicle body 12 by using not only the first band 40 but also a second band 42. The second band 42 also extends in the circumferential direction along the tank side surface 25, and both ends of the second band 42 are fixed to the vehicle body 12. For example, the width of the second band 42 may be 30 mm or more and 40 mm or less. Although not particularly limited, the second tank 22b and the third tank 22c have the same size as that of the first tank 22a. That is, the lengths of the second tank 22b and the third tank 22c are approximately 1530 mm. The diameters of the second tank 22b and the third tank 22c are approximately 300 mm. The distance D1 from the base-side end 24 to the first band 40 is also approximately 300 mm. A distance D2 from the valve-side end 26 to the second band 42 is approximately 270 mm. The numerical value related to the distance D2 will also be described in detail later. Similarly to the first tank 22a, each of the second tank 22b and the third tank 22c is further fixed to the vehicle body 12 by using the neck mount 36.

As described above, in the vehicle 10 of this embodiment, the tanks 22 are mounted on the vehicle body 12, and the automatic valve 30 is attached to the cap 28 of each tank 22. As described above, the automatic valve 30 is, for example, a solenoid valve, and generates the operating noise such as clicking noise when the valve is opened or closed. The operating noise (vibration) of the automatic valve 30 may be transmitted from the automatic valve 30 to the tank 22, from the tank 22 to the bands 40 and 42, and from the bands 40 and 42 to the vehicle body 12 and perceived by the user in the vehicle (that is, in the cabin 12c).

In this regard, the operating noise (vibration) of the automatic valve 30 has a common characteristic (for example, a similar frequency distribution). As a result of simulating the behavior of the tank 22 by a computer in consideration of the characteristic of the operating noise, it has been found that the tank vibrates in a specific mode when the operating noise of the automatic valve 30 is transmitted to the tank 22. As illustrated in FIG. 6, in this specific mode, a center point CN in a longitudinal direction of the tank 22 vibrates with the largest amplitude as an antinode of vibration. In a section between the center point CN and the base-side end 24 and in a section between the center point CN and the valve-side end 26, points N1 and N2 having minimum amplitudes appear as nodes of vibration, respectively. It has been found that the positions of the nodes N1 and N2 vary depending on the length of the tank.

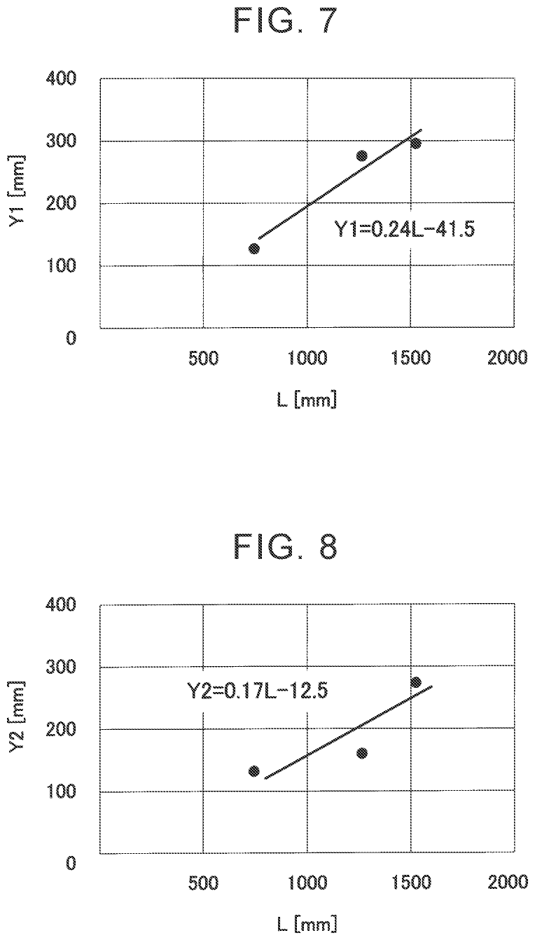

FIG. 7 illustrates results of the above simulation for the first node N1 appearing in the section between the center point CN and the base-side end 24. As illustrated in FIG. 7, when a length L of the tank 22 is approximately 1530 mm, a distance Y1 from the base-side end 24 to the first node N1 is approximately 300 mm. When the length L of the tank 22 is approximately 1270 mm, the distance Y1 from the base-side end 24 to the first node N1 is approximately 280 mm. When the length L of the tank 22 is approximately 750 mm, the distance Y1 from the base-side end 24 to the first node N1 is approximately 125 mm. These results demonstrate that there is a relationship of Y1=0.24×L−41.5 mm between the distance Y1 from the base-side end 24 to the first node N1 and the length L of the tank 22, and a variation of ±15 mm may actually occur with respect to the relational expression.

FIG. 8 illustrates results of the simulation for the second node N2 appearing in the section between the center point CN and the valve-side end 26. As illustrated in FIG. 8, when the length L of the tank 22 is approximately 1530 mm, a distance Y2 from the valve-side end 26 to the second node N2 is approximately 270 mm. When the length L of the tank 22 is approximately 1270 mm, the distance Y2 from the valve-side end 26 to the second node N2 is approximately 170 mm. When the length L of the tank 22 is approximately 750 mm, the distance Y2 from the valve-side end 26 to the second node N2 is approximately 130 mm. These results demonstrate that there is a relationship of Y2=0.17×L−12.5 mm between the distance Y2 from the valve-side end 26 to the second node N2 and the length L of the tank 22, and a variation of ±15 mm may actually occur with respect to the relational expression.

Based on the findings described above, the positions of the vibration nodes N1 and N2 on the tank 22 can be determined in advance from the length L of the tank 22. The bands 40 and 42 for fixing the tank 22 to the vehicle body 12 can be provided at or near the positions of the vibration nodes N1 and N2, respectively. Specifically, when the distance Y1 calculated for the first node N1 is defined as a first predetermined distance, it is appropriate that the first band 40 be arranged within a range of the first predetermined distance ±15 mm (that is, Y1±15 mm) from the base-side end 24. When the distance Y2 calculated for the second node N2 is defined as a second predetermined distance, it is appropriate that the second band 42 be arranged within a range of the second predetermined distance ±15 mm (that is, Y2±15 mm) from the valve-side end 26. The vehicle 10 in this embodiment is designed so that the distances D1 and D2 (see FIGS. 3 and 4) satisfy these relationships.

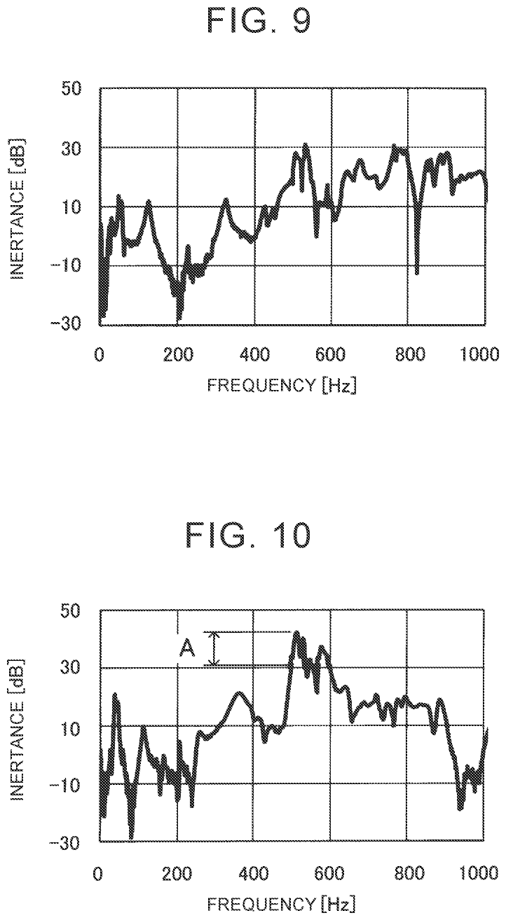

FIG. 9 illustrates inertance measured in the vehicle 10 of this embodiment. FIG. 10 illustrates inertance measured in a related-art vehicle as a comparative example. As indicated by an arrow A in FIG. 10, in the vehicle 10 of this embodiment, transmission of vibration caused by the operating noise of the automatic valve 30 is significantly suppressed as compared with the related-art vehicle. As a result, it is possible to avoid or suppress the perception of the operating noise by the user in the vehicle. The related-art vehicle herein means that the positions of the first band 40 and the second band 42 in the vehicle 10 of this embodiment are determined based on a design concept of the related art.

Although the embodiment is described above in detail, the embodiment is only illustrative and is not intended to limit the claims. The technologies described in the claims encompass various modifications and changes to the specific examples described above. The technical elements described herein or illustrated in the drawings exert technical utility solely or in various combinations, and are not limited to the combination described in the claims as filed. The technologies described herein or illustrated in the drawings may simultaneously achieve a plurality of objects, and exert technical utility by achieving one of the objects.

What is claimed is:

1. A fuel cell vehicle comprising:
a vehicle body;
a tank mounted on the vehicle body and configured to store gas;
a fuel cell unit configured to generate electricity by using the gas supplied from the tank; and
a first band configured to fix the tank to the vehicle body,
wherein the tank includes a valve-side end including a cap to which an automatic valve is attached, a base-side end opposite to the valve-side end, and a cylindrical tank side surface extending between the valve-side end and the base-side end,
wherein the first band extends in a circumferential direction along the tank side surface, and is located within a range of a first predetermined distance ±15 mm from the base-side end or within a range of a second predetermined distance ±15 mm from the valve-side end, and
wherein the following relational expressions are satisfied,
Y1=0.24×L−41.5 mm, and
Y2=0.17×L−12.5 mm,
where Y1 represents the first predetermined distance, Y2 represents the second predetermined distance, and L represents a length of the tank.

2. The fuel cell vehicle according to claim 1, further comprising a second band extending in the circumferential direction along the tank side surface and configured to fix the tank to the vehicle body,
wherein the first band is located within the range of the first predetermined distance ±15 mm, and the second band is located within the range of the second predetermined distance ±15 mm.

3. The fuel cell vehicle according to claim 1, further comprising a neck mount configured to fix the valve-side end of the tank to the vehicle body.

4. The fuel cell vehicle according to claim 1, wherein the length of the tank is 500 mm or more and 1800 mm or less.

5. The fuel cell vehicle according to claim 1, wherein a diameter of the tank is 200 mm or more and 400 mm or less.

6. The fuel cell vehicle according to claim 1, wherein the tank is made of a carbon fiber reinforced resin.
